(19) United States
(12) Patent Application Publication
(10) Pub. No.: US 2016/0001520 A1
(43) Pub. Date: Jan. 7, 2016

(54) IMPROVED BEVERAGE DISPENSING TUBING

(71) Applicant: VALPAR INDUSTRIAL LIMITED, Bangor (GB)

(72) Inventor: Mervyn WATERWORTH, Bangor (GB)

(73) Assignee: VALPAR INDUSTRIAL LIMITED, Bangor (GB)

(21) Appl. No.: 14/770,530

(22) PCT Filed: Feb. 19, 2014
(86) PCT No.: PCT/GB2014/050477

§ 371 Date: Aug. 26, 2015

(30) Foreign Application Priority Data
Feb. 28, 2013 (GB) 1303619.9

(51) Int. Cl. B32B 1/08; B32B 27/08; B67D 1/08; B32B 27/34; B32B 27/32; F16L 11/04; B32B 7/12; B32B 27/30

(52) U.S. Cl. CPC B32B 1/08; B32B 7/12; B32B 27/08; B32B 27/306; B32B 27/34; B32B 27/32; F16L 11/04; B67D 1/0801; B32B 2307/7145; B32B 2307/7244

(57) ABSTRACT

The present invention relates to improved beverage dispensing tubing, particularly suitable for transporting beer or ale, which requires less cleaning than current tubing. The tubing has a multi-layered structure where at least one of the layers is a gas barrier layer. It is further envisaged that incorporation of the tubing into a python beverage delivery system for the remote dispensing of beverages would be advantageous.

The present invention relates to improved beverage dispensing tubing, particularly suitable for transporting beer or ale, which requires less cleaning than current tubing. The tubing has a multi-layered structure where at least one of the layers is a gas barrier layer. It is further envisaged that incorporation of the tubing into a python beverage delivery system for the remote dispensing of beverages would be advantageous.

Flexible tubing for transporting beer or ale (or other beverages) from a cellar to the point of dispense has been available for a considerable time and is well known in the beverage industry. Originally, the flexible tubing was of a relatively simple construction and comprised monolayer polymers such as low or medium density polythene (LDPE, MDPE), ethylene vinyl acetate (EVA) or plasticised polyvinyl chloride (PVC). Whilst this type of flexible tubing functioned to transport the beverage from a cellar to the point of dispense as required, it also needs frequent cleaning to remove bacteria and yeast buildup on the inner surface of the tubing. Frequent cleaning is particularly important as the bacterial and yeast buildup on the inside of the tubing greatly affects the beer taste and quality. Typically, for tubing that is used to transport beer or ale, it was found that the tubing required cleaning on a weekly basis.

One of the main reasons for rapid formation of bacteria is that the inner surface of these tube materials has an inner surface with sufficient roughness to encourage (or at least not discourage) bacterial and yeast adhesion.

This problem has led to the development of multilayer beverage tubing incorporating a nylon inner layer that slows down the adherence of the bacteria to such an extent that the cleaning cycle can be increased to between 3 and 5 weeks.

However, this cycle is still both onerous and costly and it will be understood that it would be advantageous to further reduce the requirements for cleaning and thus further increase the amount of time between cleans.

The present invention aims to obviate or mitigate one or more of the problems associated with the prior art.

Throughout this document the terms tubing or tube can be taken to be a tube of any appropriate cross-section which has a hollow core.

According to an aspect of the present invention there is provided beverage dispensing tubing comprising multiple layers where at least one of the layers is a gas barrier layer.

It has been noted that although the inclusion of a nylon layer reduced the adhesion of bacteria, the tubing materials still allow for the permeation of oxygen from the surrounding air through the plastic wall to the inside of the tubing which provides an appropriate environment for bacterial proliferation. Advantageously by including a layer of gas barrier material in a multilayer beverage dispensing tube, oxygen permeation through the tubing is practically eliminated. This prevents the ingress of oxygen through the tubing into the core of the tube thus retarding bacterial growth and proliferation.

Preferably the gas barrier layer is a layer of ethylene vinyl alcohol (EVOH).

By incorporating an additional layer of ethylene vinyl alcohol (EVOH) within the tube wall, oxygen permeation through the tubing is practically eliminated.

Preferably the layer of ethylene vinyl alcohol (EVOH) has a thickness in the range of 50-150 micron.

Most preferably the layer of ethylene vinyl alcohol (EVOH) has a thickness of approximately 100 micron.

Typically a 100 micron thick barrier layer of EVOH will reduce the oxygen permeation though the tube wall by a factor of more than 80 when compared to a monolayer polythene tube of similar size.

Preferably, the beverage dispensing tubing comprises an inner layer of polyamide.

It is preferred that the polyamide is Nylon 11.

Preferably, the polyamide has a wall thickness in the range of 150-250 micron.

Most preferably the polyamide has a wall thickness of around 200 micron.

The polyamide assists in retarding the adhesion of bacteria and yeast.

Most preferably the gas barrier layer is bonded to the inner layer of polyamide.

Preferably, the beverage dispensing tubing comprises an outer layer of polymeric material.

Preferably the outer layer of polymeric material is polythene or ethylene vinyl acetate (EVA).

The thickness of the outer layer is determined by the overall dimensions of the tubing.

Preferably the gas barrier layer is bonded to the outer layer of polymeric material.

Preferably layers are bonded using an adhesive. Most preferably a layer of polymeric adhesive.

An example of a suitable polymeric adhesive is Orevac 18302 (or similar) of around 100 microns thickness.

Optionally the outer layer of polymeric material is blended with the layer of adhesive to form one adhering outer layer that adheres to the gas barrier layer.

The outer layer may contain longitudinal colour stripes for identification purposes.

According to another aspect of the present invention there is provided a hose bundle comprising a least one section of beverage dispensing tubing in accordance with the first aspect.

Hose bundles, commonly referred to as “pythons”, are delivery systems for remote draught dispensing of beverages. They typically consist of a bundle of plastic tubes, product lines and cooling lines encased within foam insulation. Advantageously, using tubes in accordance with the present invention in pythons reduces cleaning requirements for these products.

In order to provide a better understanding of the present invention an embodiment will be described with reference to:

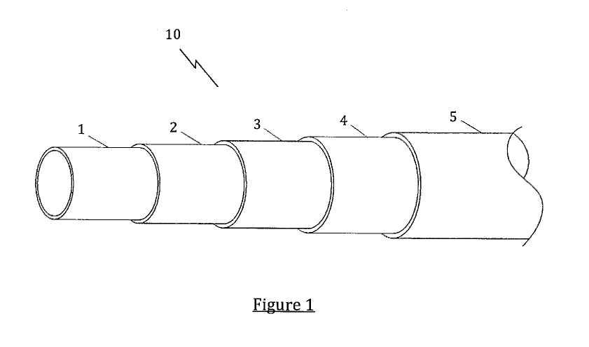

FIG. 1, which shows an exploded view of a section of tubing according to the present invention, such that each layer of tubing is shown. It will be appreciated that in use only the outer layer would be visible, and to some extent the inner layer.

A preferred embodiment of the present invention is depicted in FIG. 1. The beverage dispensing tubing 10, is made up of multiple layers. The innermost polyamide layer 1 in this embodiment is Nylon 11 which has a wall thickness of around 200 micron, although it would be appreciated by a skilled person that other polyamide materials could be used and other thicknesses of polyamide materials could be used. The innermost surface of the Nylon layer 1 has been selected partially for its anti-bacterial properties.

The Nylon layer 1 is bonded to a gas barrier layer 3 using a first layer of polymeric adhesive 2. The preferred polymeric adhesive is Orevac 18302 which is included in the tubing 10 as a layer of around 100 microns thickness. A skilled person would appreciate that alternative adhesives could be used. The preferred gas barrier layer is a layer of ethylene vinyl alcohol (EVOH) 3. It has been found by the inventors that inclusion of this 100 micron thick gas barrier layer of ethylene vinyl alcohol (EVOH) 3 in the laminate structure of the tubing 10 will reduce the oxygen permeation though the tube wall by a factor of more than 80 when compared to a monolayer polythene tube of similar size. It will however be appreciated that other thicknesses of gas barrier layer may be used.

A second layer of polymeric adhesive in the form of a layer of Orevac 18302 4 (or similar) of around 100 microns is used to bond the ethylene vinyl alcohol EVOH layer 3 to an polymeric outer layer that in this embodiment is a layer of polythene 5. It is appreciated that the polythene could be replaced with another polymeric material such as EVA.

The thickness of the outer layer is determined by the overall dimensions of the tubing.

The preferred tubing 10 that is shown in FIG. 1 has the following preferred dimensions and characteristics when being used as tubing for the UK beer industry;

Inner diameter: 0.265″

Outer diameter: 0.375″

Inner layer: Nylon 11, 0.008″ thickness

Tie layer: Orevac 18302, 0.004″ thickness

Barrier Layer: EVOH, 0.004″ thickness

Tie layer: Orevac 18302, 0.004″ thickness

Outer layer: LDPE, 0.039″ thickness.

In an alternative embodiment, rather than the multilayer tubing 10 comprising five layers (some of which are layers of adhesive), the materials used for outer two layers, namely the polythene layer (or other polymeric material layer) and second layer of adhesive, may be blended together and used to form one adhering outer layer that adheres to the middle gas barrier layer (EVOH).

In a preferred embodiment at least the outer layer (either the outer polymeric material layer or the combined adhering outer layer) contains longitudinal colour stripes or other identifiable colouration for identification purposes.

The present invention provides, a simple and unexpectedly effective improvement to beverage dispensing tubing. Tests have shown that this construction of beer tubing extends the cleaning cycle by up to 12 weeks.

1. A beverage dispensing tubing apparatus comprising multiple layers wherein at least one of the layers comprises a gas barrier layer.

2. The beverage dispensing tubing apparatus as claimed in claim 1 wherein the gas barrier layer is a layer of ethylene vinyl alcohol (EVOH).

3. The beverage dispensing tubing apparatus as claimed in claim 1 wherein the layer of ethylene vinyl alcohol (EVOH) has a thickness in the range of 50 -150 micron.

4. The beverage dispensing tubing apparatus as claimed in claim wherein the layer of ethylene vinyl alcohol (EVOH) has a thickness of approximately 100 micron.

5. The beverage dispensing tubing apparatus as claimed in any preceding claim 1 wherein the beverage dispensing tubing comprises an inner layer of polyamide.

6. The beverage dispensing tubing apparatus as claimed in claim 5 wherein the polyamide is Nylon 11.

7. The beverage dispensing tubing apparatus as claimed 5 wherein the polyamide has a wall thickness in the range of 150-250 micron.

8. The beverage dispensing tubing apparatus as claimed in claim 5 wherein the polyamide has a wall thickness of around 200 micron.

9. The beverage dispensing tubing apparatus as claimed in claim 4 wherein the gas barrier layer is bonded to the inner layer of polyamide.

10. The beverage dispensing tubing apparatus as claimed in claim 1 wherein the beverage dispensing tubing comprises an outer layer of polymeric material.

11. The beverage dispensing tubing apparatus as claimed in claim 10 wherein the outer layer of polymeric material is polythene or ethylene vinyl acetate (EVA).

12. The beverage dispensing tubing apparatus as claimed in claim 10 wherein the gas barrier layer is bonded to the outer layer of polymeric material.

13. The beverage dispensing tubing apparatus as claimed in claim 1 wherein layers are bonded using an adhesive.

14. The beverage dispensing tubing apparatus as claimed in claim 13 wherein the adhesive is a layer of polymeric adhesive.

15. The beverage dispensing tubing apparatus as claimed in claim 10 wherein the outer layer of polymeric material is blended with a layer of adhesive to form one adhering outer layer that adheres to the gas barrier layer.

16. The beverage dispensing tubing apparatus as claimed in claim 1 wherein the outer surface has longitudinal colour stripes for identification purposes.

17. A hose bundle comprising:
at least one section of beverage dispensing tubing apparatus comprising multiple layers; and
wherein at least one of the layers comprises a gas barrier layer.
